(19) United States
(12) Patent Application Publication
(10) Pub. No.: US 2026/0353527 A1
(43) Pub. Date: Nov. 5, 2026

(54) RESONANT CONVERSION SYSTEM

(71) Applicant: Delta Electronics, Inc., Taoyuan City (TW)

(72) Inventors: Ching-Ho Chou, Taoyuan City (TW); Yung-Chuan Lu, Taoyuan City (TW)

(21) Appl. No.: 19/264,391

(22) Filed: Jul. 9, 2025

(30) Foreign Application Priority Data
May 2, 2025 (TW) 114116533

(51) Int. Cl. H05B 41/282; H02M 1/36; H02M 3/00

(52) U.S. Cl. CPC H05B 41/2824; H02M 1/36; H02M 3/01

(57) ABSTRACT

A resonant conversion system is provided. The resonant conversion system receives and converts an input voltage to provide a power to a light source. The resonant conversion system includes a boost converter, an energy regulation unit and a resonant converter. The boost converter boosts and converts the input voltage to a transition voltage. The energy regulation unit regulates the transition voltage. The resonant converter is connected between the boost converter and the light source and converts the transition voltage to an output voltage for providing the output voltage to the light source. The output voltage is varied accordingly by adjusting the transition voltage through the energy regulation unit.

### CROSS-REFERENCE TO RELATED APPLICATION

This application claims the priority to Taiwan Patent Application No. 114116533, filed on May 02, 2025, the entirety of which is hereby incorporated by reference.

### FIELD OF THE INVENTION

The present disclosure relates to a resonant conversion system, and more particularly to a resonant conversion system for enhancing applicability.

### BACKGROUND OF THE INVENTION

During the COVID-19 pandemic, the application of ultraviolet lamp gradually gained attention. The resonant conversion system used to control the ultraviolet lamp is a topic of interest for industry research. The conventional resonant conversion system used for the ultraviolet lamp only provide a fixed output voltage to provide the power to the ultraviolet lamp. However, certain types of the ultraviolet lamp, such as the ultraviolet lamp with a wavelength of 222 nm, requires energy regulation to protect the cornea and sterilize wounds effectively. The conventional resonant conversion system is limited by its lack of energy regulation capabilities, which in turn diminishes its overall applicability.

Therefore, there is a need of providing a resonant conversion system to obviate the drawbacks encountered from the prior arts.

### SUMMARY OF THE INVENTION

The present disclosure provides a resonant conversion system. The resonant conversion system of the present disclosure includes an energy regulation unit. The energy regulation unit regulates the transition voltage outputted by the boost converter. The output voltage outputted by the resonant converter is varied accordingly by adjusting the transition voltage through the energy regulation unit. Consequently, the output voltage of the resonant conversion system supplied to the light source can be regulated according to requirement. For example, the output voltage of the resonant converter may be adjusted according to variations in the output power of the light source. The output power of the light source is maintained consistently. Consequently, the applicability of the resonant conversion system can be enhanced.

In accordance with an aspect of the present disclosure, a resonant conversion system is provided. The resonant conversion system receives and converts an input voltage to provide a power to a light source. The resonant conversion system includes a boost converter, an energy regulation unit and a resonant converter. The boost converter boosts and converts the input voltage to a transition voltage. The energy regulation unit regulates the transition voltage. The resonant converter is connected between the boost converter and the light source and converts the transition voltage to an output voltage for providing the output voltage to the light source. The output voltage is varied accordingly by adjusting the transition voltage through the energy regulation unit.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a resonant conversion system according to a first embodiment of the present disclosure;

FIG. 2 is a schematic circuit diagram illustrating a resonant conversion system according to a second embodiment of the present disclosure;

FIG. 3 is a schematic circuit diagram illustrating a resonant conversion system according to a third embodiment of the present disclosure; and

FIG. 4 is a schematic circuit diagram illustrating a resonant conversion system according to a fourth embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

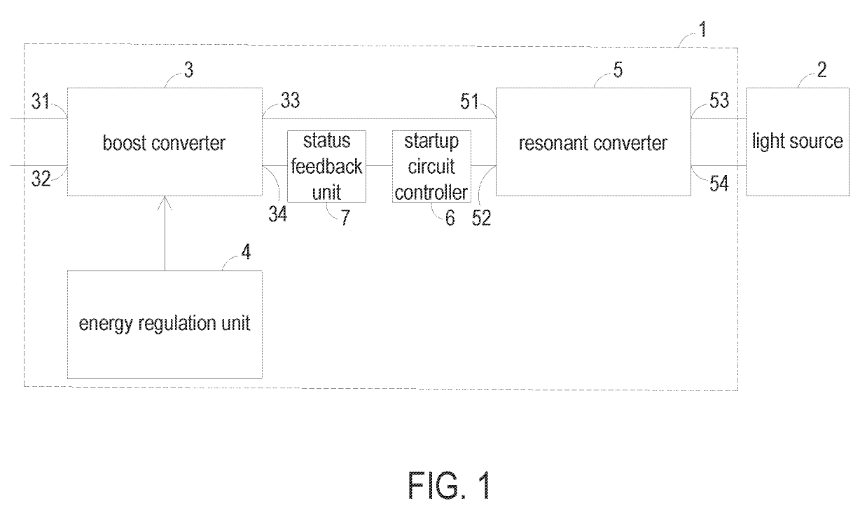

FIG. 1 is a schematic circuit diagram illustrating a resonant conversion system according to a first embodiment of the present disclosure. As shown in FIG. 1, the resonant conversion system 1 of this embodiment receives an input voltage and converts the input voltage into an output voltage to provide a power to a light source 2. The input voltage is a DC voltage with 12V or 24V provided by a battery of a portable device. Preferably but not exclusively, the light source 2 is an ultraviolet lamp. The resonant conversion system 1 includes a boost converter 3, an energy regulation unit 4 and a resonant converter 5.

The boost converter 3 boosts and converts the input voltage into a transition voltage. The boost converter 3 includes a first input terminal 31, a second input terminal 32, a first output terminal 33 and a second output terminal 34. The boost converter 3 receives the input voltage through the first input terminal 31 and the second input terminal 32. The boost converter 3 outputs the transition voltage through the first output terminal 33 and the second output terminal 34. In this embodiment, the second input terminal 32 and the second output terminal 34 are grounded. The energy regulation unit 4 is connected to the boost converter 3 to regulate the transition voltage outputted by the boost converter 3. The resonant converter 5 is a current-fed push-pull parallel resonant converter. The resonant converter 5 is connected between the boost converter 3 and the light source 2. The resonant converter 5 converts the transition voltage outputted from the boost converter 3 into an output voltage for providing power to the light source 2. The resonant converter 5 includes a first input terminal 51, a second input terminal 52, a first output terminal 53, and a second output terminal 54. The resonant converter 5 receives the transition voltage through the first input terminal 51 and the second input terminal 52. The resonant converter 5 outputs the output voltage through the first output terminal 53 and the second output terminal 54. The first input terminal 51 of the resonant converter 5 is directly connected to the first output terminal 33 of the boost converter 3. The second input terminal 52 and the second output terminal 54 of the resonant converter 5 are grounded. The output voltage outputted by the resonant converter 5 is varied accordingly by adjusting the transition voltage through the energy regulation unit 4. For example, the energy regulation unit 4 may adjust the transition voltage, so that the variation range of the adjusted transition voltage is within ±2V of the original transition voltage. Consequently, the variation range of the adjusted output voltage is within ±2V of the original output voltage. The light source 2 is capable of energy regulation.

From above, the resonant conversion system 1 of the present disclosure includes an energy regulation unit 4. The energy regulation unit 4 regulates the transition voltage outputted by the boost converter 3. The output voltage outputted by the resonant converter 5 is varied accordingly by adjusting the transition voltage through the energy regulation unit 4. Consequently, the output voltage of the resonant conversion system 1 supplied to the light source 2 can be regulated according to requirement. For example, the output voltage of the resonant converter 5 may be adjusted according to variations in the output power of the light source 2. The output power of the light source 2 is maintained consistently. Consequently, the applicability of the resonant conversion system 1 can be enhanced.

In this embodiment, the resonant conversion system 1 further includes a startup circuit controller 6 and a status feedback unit 7. The startup circuit controller 6 is connected between the second output terminal 34 of the boost converter 3 and the second input terminal 52 of the resonant converter 5. The startup circuit controller 6 is configured to receive a control signal provided by an external unit to control the operation of the resonant converter 5. For example, when the startup circuit controller 6 receives a control signal indicating an ON state, the startup circuit controller 6 activates the resonant converter 5. When the control signal indicates an OFF state, the startup circuit controller 6 stops the operation of the resonant converter 5. The status feedback unit 7 is connected between the second output terminal 34 of the boost converter 3 and the startup circuit controller 6. The status feedback unit 7 is configured to determine the status of the light source 2 according to the transition voltage between the boost converter 3 and the resonant converter 5 and a transition current associated with the transition voltage. The detailed structural features of the status feedback unit 7 will be described hereinafter.

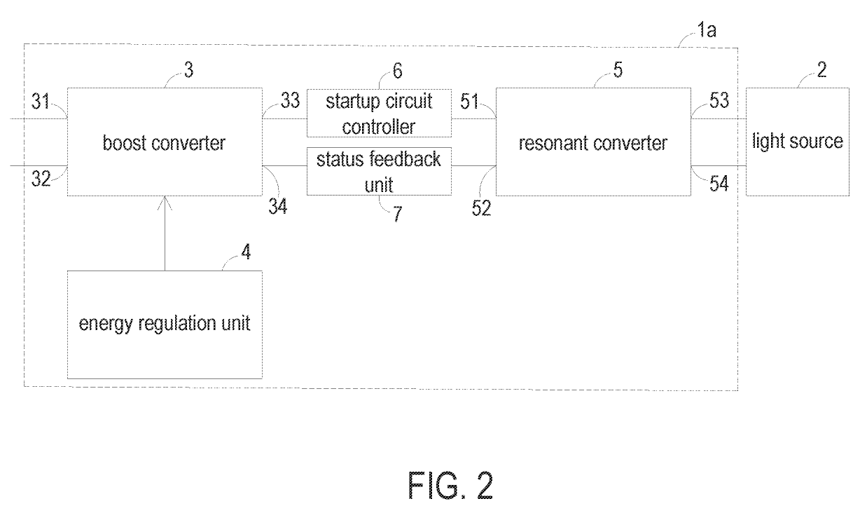

FIG. 2 is a schematic circuit diagram illustrating a resonant conversion system according to a second embodiment of the present disclosure. Compared to the resonant conversion system 1 of FIG. 1, as shown in FIG. 2, the resonant conversion system 1a of this embodiment is directly connected between the first output terminal 33 of the boost converter 3 and the first output terminal 51 of the resonant converter 5. The status feedback unit 7 is connected between the second output terminal 34 of the boost converter 3 and the second output terminal 52 of the resonant converter 5. The startup circuit controller 6 and the status feedback unit 7 are independent to each other.

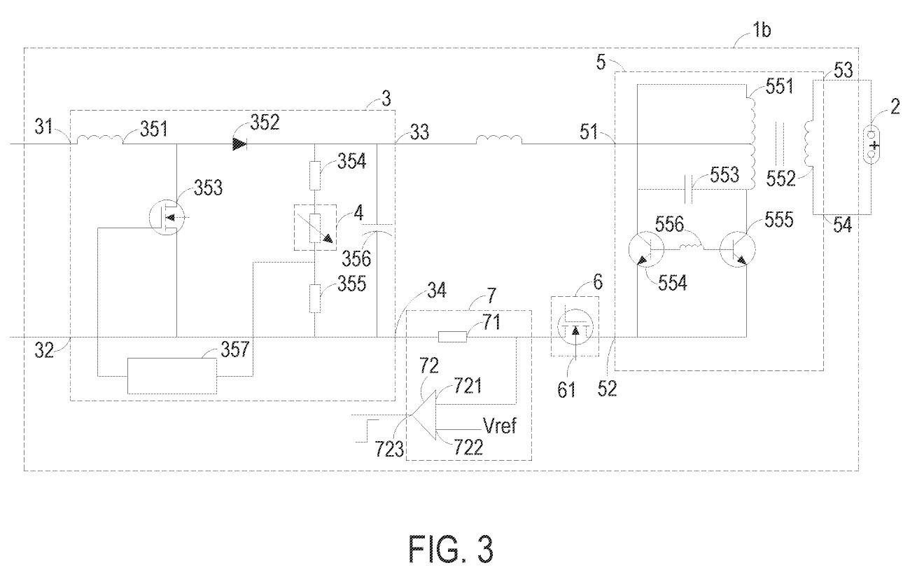

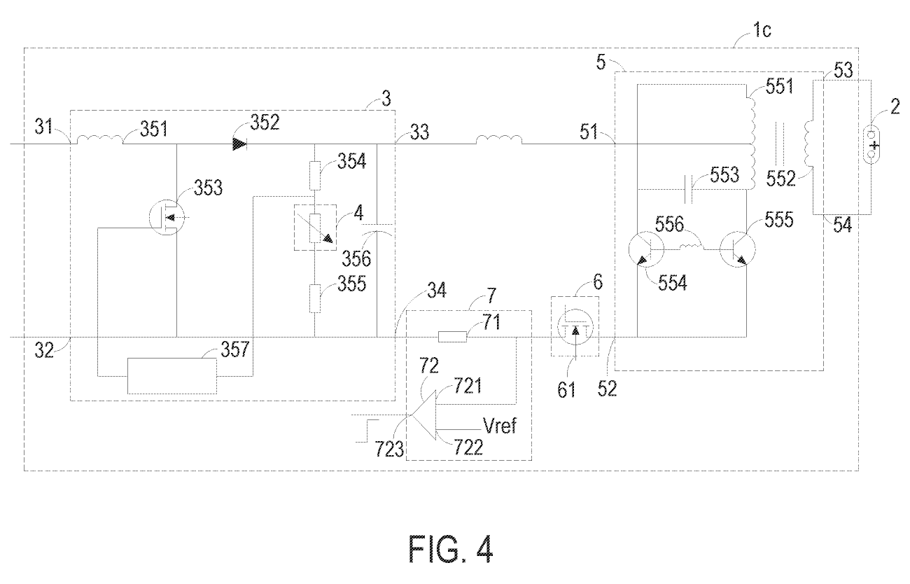

FIG. 3 is a schematic circuit diagram illustrating a resonant conversion system according to a third embodiment of the present disclosure. Compared to the resonant conversion system 1 of FIG. 1, as shown in FIG. 3, the energy regulation unit 4 of the resonant conversion system 1b of this embodiment is disposed within the boost converter 3. The boost converter 3 includes a first inductor 351, a diode 352, a first switch 353, a first resistor 354, a second resistor 355, a first capacitor 356, a control chip 357 and the energy regulation unit 4. The first inductor 351 and the diode 352 are connected in series between the first input terminal 31 and the first output terminal 33. A first terminal of the first switch 353 is connected to the connection point between the first inductor 351 and the diode 352. A second terminal of the first switch 353 is connected to the second input terminal 32. The first resistor 354, the energy regulation unit 4, and the second resistor 355 are connected in series between the first output terminal 33 and the second output terminal 34 in sequence. Namely, the first resistor 354 and the energy regulation unit 4 are connected in series. A first connection point is formed between the first resistor 354 and the energy regulation unit 4. The energy regulation unit 4 and the second resistor 355 are connected in series. A second connection point is formed between the energy regulation unit 4 and the second resistor 355. The first capacitor 356 is connected between the first output terminal 33 and the second output terminal 34. One end of the control chip 357 is connected to a third terminal of the first switch 353, and the other end of the control chip 357 is connected to the second connection point between the second resistor 355 and the energy regulation unit 4. The control chip 357 performs control according to a feedback signal from the energy regulation unit 4 and transmits a signal to control the first switch 353 to regulate the transition voltage. In another embodiment, the position of the control chip 357 may be adjusted. For example, as shown in FIG. 4, one end of the control chip 357 is connected to the third terminal of the first switch 353, and the other end of the control chip 357 is connected to the first connection point between the first resistor 354 and the energy regulation unit 4. In an embodiment, the control chip 357 transmits a signal to control the first switch 353 to regulate the transitional voltage according to the feedback signal from the first connection point or the second connection point. The energy regulation unit 4 is composed of a variable resistor. The transition voltage is correlated with the resistance value of the variable resistor. The resistance value of the variable resistor can be manually adjusted. Consequently, the output voltage is varied accordingly by adjusting the resistance value of the variable resistor. Namely, the intensity of the light source 2 can be correspondingly increased or decreased by manually adjusting the resistance value of the variable resistor.

In this embodiment, the startup circuit controller 6 is composed of a series switch. The resonant converter 5 is activated when the series switch is turned on, so that the light source 2 is driven to be operated. Conversely, the resonant converter 5 stops operating when the series switch is turned off, so that the light source 2 is stopped. In an embodiment, the startup circuit controller 6 includes a driving terminal 61. The driving terminal 61 is implemented by the gate of a field-effect transistor. The driving terminal 61 is activated when a user presses a startup button, so that the light source 2 is operated. The status feedback unit 7 includes a current sampling unit 71 and a comparator 72. The current sampling unit 71 may be implemented as a series-connected variable resistor, a current transformer, or other components capable of indicating the voltage at the location based on the current flowing through the component. The current sampling unit 71 is connected between the boost converter 3 and the startup circuit controller 6. When the light source 2 is illuminated, the current flowing through the current sampling unit 71 generates a voltage drop. The comparator 72 includes a first terminal 721, a second terminal 722, and a third terminal 723. The comparator 72 receives the voltage drop across the current sampling unit 71 through the first terminal 721. The comparator 72 compares the voltage drop with a reference voltage Vref received by the second terminal 722. When the voltage drop across the current sampling unit 71 is greater than the reference voltage Vref, the comparator 72 outputs a first potential signal (e.g., a high-level signal) through the third terminal 723 to indicate that the light source 2 is in a first state (e.g., an activated state). The first state of the light source 2 is fed back to an external receiver (not shown). When the voltage drop across the current sampling unit 71 is less than the reference voltage Vref, the comparator 72 outputs a second potential signal (e.g., a low-level signal) through the third terminal 723 to indicate that the light source 2 is in a second state (e.g., a stopped state). The second state of the light source 2 is fed back to an external receiver (not shown). The first potential signal is different from the second potential signal. The first state is different from the second state. Certainly, in some embodiments, the logic for determining the first potential signal and second potential signal may vary according to requirement. For example, when the voltage drop across the current sampling unit 71 is greater than the reference voltage Vref, the comparator 72 outputs a first potential signal (e.g., a high-level signal) through the third terminal 723 to indicate that the light source 2 is in a second state (e.g., a stopped state). The first state of the light source 2 is fed back to an external receiver (not shown). When the voltage drop across the current sampling unit 71 is less than the reference voltage Vref, the comparator 72 outputs a second potential signal (e.g., a low-level signal) through the third terminal 723 to indicate that the light source 2 is in a first state (e.g., an activated state). The second state of the light source 2 is fed back to an external receiver (not shown).

In this embodiment, the resonant converter 5 includes a first primary winding 551, a secondary winding 552, a second capacitor 553, a second switch 554, a third switch 555 and a second primary winding inductor 556. The first input terminal 51 is connected to the first primary winding 551. The secondary winding 552 is connected between the first output terminal 53 and the second output terminal 54. The second capacitor 553 is connected between a first end and a second end of the first primary winding 551. The second switch 554 is connected between a first end of the first primary winding 551 and the second input terminal 52. The third switch 555 is connected between the second end of the first primary winding 551 and the second input terminal 52. The second primary winding inductor 556 is connected between the second switch 554 and the third switch 555.

As mentioned above, the resonant conversion system of the present disclosure includes an energy regulation unit. The energy regulation unit regulates the transition voltage outputted by the boost converter. The output voltage outputted by the resonant converter is varied accordingly by adjusting the transition voltage through the energy regulation unit. Consequently, the output voltage of the resonant conversion system supplied to the light source can be regulated according to requirement. For example, the output voltage of the resonant converter may be adjusted according to variations in the output power of the light source. The output power of the light source is maintained consistently. Consequently, the applicability of the resonant conversion system can be enhanced. Moreover, the resonant conversion system of the present disclosure includes a startup circuit controller and a status feedback unit. The resonant conversion system utilizes the startup circuit controller to control the operation state of the resonant converter and employs the status feedback unit to detect and provide feedback on the status of the light source. Consequently, the resonant conversion system of the present disclosure can achieve multiple functions simultaneously for enhancing the overall functionality of the resonant conversion system.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A resonant conversion system receiving and converting an input voltage to provide a power to a light source, and the resonant conversion system comprising:
a boost converter boosting and converting the input voltage to a transition voltage;
an energy regulation unit regulating the transition voltage; and
a resonant converter connected between the boost converter and the light source, converting the transition voltage to an output voltage for providing the output voltage to the light source, wherein the output voltage is varied accordingly by adjusting the transition voltage through the energy regulation unit.

2. The resonant conversion system according to claim 1, wherein the energy regulation unit is disposed within the boost converter, and the energy regulation unit is composed of a variable resistor, wherein the output voltage is varied accordingly by adjusting a resistance value of the variable resistor.

3. The resonant conversion system according to claim 1, wherein the resonant conversion system further comprises a startup circuit controller, the startup circuit controller is connected between the boost converter and the resonant converter, and the startup circuit controller receives a control signal to control the operation of the resonant converter.

4. The resonant conversion system according to claim 3, wherein the startup circuit controller is composed of a series switch, wherein the resonant converter is activated when the series switch is turned on, and the resonant converter stops operating when the series switch is turned off.

5. The resonant conversion system according to claim 1, wherein the resonant conversion system further comprises a status feedback unit, the status feedback unit is connected between the boost converter and the resonant converter, and the status feedback unit determines a status of the light source according to the transition voltage and a transition current between the boost converter and the resonant converter.

6. The resonant conversion system according to claim 5, wherein the status feedback unit comprises a current sampling unit and a comparator, wherein the current sampling unit is connected between the boost converter and the resonant converter, the current sampling unit comprises a voltage drop, the comparator comprises a first terminal, a second terminal and a third terminal, the comparator receives the voltage drop through the first terminal and the comparator compares the voltage drop with a reference voltage received by the second terminal, when the voltage drop is greater than the reference voltage, the comparator outputs a first potential signal through the third terminal to indicate that the light source is in a first state.

7. The resonant conversion system according to claim 6, wherein the status feedback unit comprises a current sampling unit and a comparator, wherein the current sampling unit is connected between the boost converter and the resonant converter, the current sampling unit comprises a voltage drop, the comparator comprises a first terminal, a second terminal and a third terminal, the comparator receives the voltage drop through the first terminal and the comparator compares the voltage drop with a reference voltage received by the second terminal, when the voltage drop is less than the reference voltage, the comparator outputs a second potential signal through the third terminal to indicate that the light source is in a second state, wherein the first potential signal is different from the second potential signal, and the first state is different from the second state.

8. The resonant conversion system according to claim 1, wherein the resonant conversion system further comprises a startup circuit controller and a status feedback unit, the startup circuit controller and the status feedback unit are connected between the boost converter and the resonant converter, respectively, the startup circuit controller and the status feedback unit are independent to each other.

9. The resonant conversion system according to claim 1, wherein the resonant conversion system further comprises a startup circuit controller and a status feedback unit, the startup circuit controller is connected between the boost converter and the resonant converter, the status feedback unit is connected between the boost converter and the resonant converter.

10. The resonant conversion system according to claim 1, wherein the boost converter comprises a first input terminal, a second input terminal, a first output terminal, a second output terminal, a first inductor, a diode, a first switch, a first resistor, a second resistor, a first capacitor, a control chip and the energy regulation unit, the boost converter receives the input voltage through the first input terminal and the second input terminal, the boost converter outputs the transition voltage through the first output terminal and the second output terminal, the first inductor and the diode are connected in series between the first input terminal and the first output terminal, a first terminal of the first switch is connected to a connection point between the first inductor and the diode, a second terminal of the first switch is connected to the second input terminal, the first resistor, the energy regulation unit, and the second resistor are connected in series between the first output terminal and the second output terminal in sequence, a first connection point is formed between the first resistor and the energy regulation unit, a second connection point is formed between the energy regulation unit and the second resistor, the first capacitor is connected between the first output terminal and the second output terminal, one end of the control chip is connected to a third terminal of the first switch, the other end of the control chip is connected to the first connection point or the second connection point, and the control chip transmits a signal to control the first switch to regulate the transition voltage.

11. The resonant conversion system according to claim 10, wherein the control chip transmits the signal to control the first switch to regulate the transitional voltage according to a feedback signal from one of the first connection point and the second connection point.

12. The resonant conversion system according to claim 1, wherein the boost converter comprises a first input terminal, a second input terminal, a first output terminal, a second output terminal, a first primary winding, a secondary winding, a second capacitor, a second switch, a third switch and a second primary winding inductor, the boost converter receives the input voltage through the first input terminal and the second input terminal, the boost converter outputs the transition voltage through the first output terminal and the second output terminal, the first primary winding is connected to the first input terminal, the secondary winding is connected between the first output terminal and the second output terminal, the second capacitor is connected between a first end and a second end of the first primary winding, the second switch is connected between the first end of the first primary winding and the second input terminal, the third switch is connected between the second end of the first primary winding and the second input terminal, and the second primary winding inductor is connected between the second switch and the third switch.
